(19) United States
(12) Patent Application Publication
(10) Pub. No.: US 2010/0038449 A1
(43) Pub. Date: Feb. 18, 2010

(54) Spill return nozzle

(76) Inventor: Maurizio Archetti, Versico (CH)

Correspondence Address: ABELMAN, FRAYNE & SCHWAB, 666 THIRD AVENUE, 10TH FLOOR, NEW YORK, NY, 10017, US

(21) Appl. No.: 12/387,861

(22) Filed: May 7, 2009

(30) Foreign Application Priority Data
May 8, 2008 (EP) 08425315.2

(51) Int. Cl. B05B 17/04; B05B 9/00

(52) U.S. Cl. 239/125; 239/419.5; 239/423

(57) ABSTRACT

The present invention relates to a spill return nozzle, particularly suitable for use in gas cooling, characterized in that, alongside the ducts for discharge and return of the flow of liquid, it is provided with means suitable to convey a flow of air toward the outlet of the nozzle.

With the nozzle according to the present invention it is possible to obtain an output jet with optimized shape and dimensions of the atomized droplets, thereby increasing cooling efficiency in the case of use of the nozzle in gas cooling processes.

### BACKGROUND

The present invention relates to a spill return nozzle particularly suitable for use in gas cooling.

In gas cooling, atomization of water is utilized to cool a current of hot gases inside a duct or a specific cooling tower. The evaporating water removes a large quantity of heat from the gas, lowering the temperature of gases to the required value.

In order to obtain adequate cooling of the gas it is important for water atomization to be very fine; the dimensions of the water droplets must be optimized and controlled in dimension so that they can evaporate completely and rapidly.

It is very important for the water to be totally atomized so that it can evaporate completely and no droplets of water remain in liquid state in the plant, as these droplets could cause damage to components of the plant downstream or cause dangerous scaling.

To obtain the required water atomization, two types of nozzle known from the state of the art are currently used.

A first type of nozzle currently known comprises nozzles using compressed air and water. In this type of nozzle, water and compressed air are injected together into the nozzle and the jet of high pressure air helps to atomize the water very finely. However, these prior art nozzles require very bulky and powerful compressors, which therefore consume large quantities of energy. The compressors used to operate this type of nozzle have powers which, as a function of the size of the plant, can even reach 250-300 kW.

A second type of prior art nozzle used for gas cooling comprises spill return nozzles, which differ from the previous type in that they only use water at a pressure of 30-50 bar.

For operation of this second type of spill return nozzle, pumps from 50-75 kW are used, with a considerable saving of power compared to compressed air nozzles.

Therefore, with respect to compressed air atomizer nozzles, spill return nozzles offer a great saving of energy, as they do not require compressors with such high powers, which also translates into a saving in terms of maintenance and installation costs.

These spill return nozzles guarantee a finely atomized jet, self-regulating the flow rate of water to the effective requirements of the plant, on the basis of the variations in temperature and the volume of gas to be cooled. A temperature sensitive regulation valve, installed on the return duct, regulates the flow rate of the nozzle in a manner directly proportional to the temperature without modifying the pressure of the liquid upstream of the nozzle.

However, spill return nozzles also present some drawbacks.

A first drawback is the dimensions of the droplets obtainable, which are on average larger compared to compressed air atomizer nozzles, a larger dimension of the droplets translating into lower gas cooling efficiency and higher evaporation times.

Secondly, the lower cooling efficiency is also due to lower heat exchange associated with the low droplet-gas relative velocity and with poor penetration of the jet, as the air pressure of the atomizer nozzles guarantees longer ranges due to the higher velocity of the water particles delivered from the nozzle.

Moreover, further disadvantages that affect prior art spill return nozzles are represented by the spraying angle, which is particularly wide and is not constant when the regulation thereof of varied.

Yet another disadvantage that affects prior art spill return nozzles lies in the fact that the jet emitted by the nozzle is of the hollow conical type, and this limits the efficiency of this nozzle.

### OBJECTS AND SUMMARY OF THE NEW INVENTION

The main aim of the present invention is therefore to provide a spill return nozzle that allows the drawbacks affecting prior art nozzles to be overcome.

Within this aim, an object of the present invention is to provide a spill return nozzle that combines simplicity and low cost in terms of set up and use of spill return nozzles with greater efficiency in terms of atomization and thus of heat exchange of the nozzles using pneumatic atomization.

A further object of the present invention is to provide a spill return nozzle with an output jet optimized in shape, distribution and dimension of the water particles.

Another object is to accelerate the water droplets in order to improve penetration of the spray in the gas current so as to optimize water distribution and heat exchange.

Yet another object of the present invention is to provide a spill return nozzle having an output jet composed of a full cone rather than a hollow cone.

A further object of the present invention is to provide a spill return nozzle with an output jet having a smaller spray angle compared to that of prior art spill return nozzles and which is constant in the entire regulation range.

This aim and these and other objects, which will be more apparent below from the detailed description of a preferred embodiment of the present invention, are achieved by a nozzle for the atomization of liquid, particularly for the atomization of water for use in gas cooling, of the type comprising an axial duct for discharge of the flow of liquid, characterized in that it also comprises an external annular sleeve coaxial to said duct for the flow of liquid and suitable for a flow of pressurized air to pass through.

### BRIEF DESCRIPTION OF THE DRAWINGS

Further characteristics and advantages of the present invention will be more apparent from the following detailed description, provided by way of non-limiting example, of a preferred embodiment shown in the accompanying figures, wherein:

FIG. 1 shows a longitudinal sectional view of the nozzle according to the present invention;

FIG. 2 schematically shows a detail of FIG. 1 indicated by the arrow.

### DETAILED DESCRIPTION OF THE PREFERRED EMBODIMENT

According to a preferred embodiment of the nozzle according to the present invention shown in the aforesaid figures, the spill return nozzle according to the present invention comprises a central duct indicated with the reference number 2. According to what is common to this type of nozzle, the axial duct 2 is in turn divided into an external annular duct 2a through which the flow of fluid, for example the flow of water, passes, in the direction of the outlet of the nozzle, and an internal axial duct 2b for return of the fluid from the outlet of the nozzle. As it is known, spill return nozzles are capable of self-regulating the flow delivered from the nozzle as a function of the gas temperature, optimizing the flow rate each time.

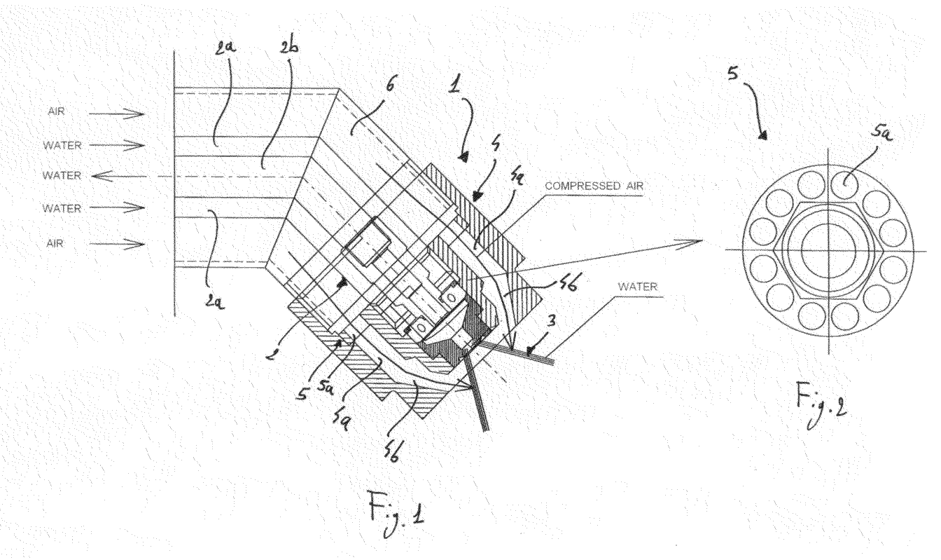

The flow delivered from the nozzle, as shown in FIG. 1, opens outward to adopt a hollow cone configuration 3 typical of this type of nozzle.

The nozzle according to the present invention also presents means suitable to convey a flow of air toward the outlet of the nozzle.

With particular reference to FIG. 1, said means suitable to convey the flow of air toward the outlet of the nozzle can advantageously comprise a substantially hollow cylindrical element 4 that surrounds said axial ducts 2a, 2b for the flow of liquid so as to create a liner between the external wall of said annular duct 2a and the internal wall of said hollow cylinder 4.

Viewed in cross section, the profile of said liner can also comprise a first rectilinear section 4a in which the flow of air runs parallel to the axial direction identified by the axis A of the nozzle, and a final convergent section 4b suitable to convey the flow of air toward the cone 3 of water delivered from the nozzle, where initial and final are intended with respect to the direction of advance of the flow of air.

Moreover, with particular reference to FIG. 2, said means suitable to convey the flow of air toward the outlet of the nozzle comprise a perforated baffle 5. Said perforated baffle 5 will preferably have a circular shape as it must be suitable for insertion into the nozzle body between said hollow cylindrical element 4 and said duct with annular section 2a. The perforated baffle will preferably comprise a plurality of holes 5a.

Said perforated baffle 5 substantially forms a centering element for the flow of air delivered to the nozzle from the duct 6 so that said flow is centered and oriented.

The presence of the ring for centering the flow of air optimizes this flow which thus flows in the first rectilinear section 4a toward the final area of the element 4 where the internal walls converge toward the axis A of the nozzle, substantially forming a final converging section 4b.

Due to the shape of the internal wall of said hollow element 4, the flow of air passes through the nozzle in a substantially axial direction until reaching the rectilinear section 4a, while it is delivered from the nozzle with an axial-centripetal direction, i.e. with a direction converging toward the axis of said nozzle represented by the arrows of FIG. 2.

According to the above description, the nozzle according to the present invention is capable of combining the advantages of a spill return nozzle, which operates with water alone and thus does not require air compressors that absorb very high power, with the advantages of a pneumatic atomization nozzle in terms of dimensions of the droplets, droplet-gas heat exchange efficiency, optimization of the droplet range, scope of the regulation range and uniformity of the jet.

The nozzle according to the present invention operates with compressed air at very low pressure, indicatively variable from 0.05 to 1 barg. Mixing of air with water takes place outside the spray orifice, and therefore substantially at atmospheric pressure.

Given the extremely modest pressures, contrary to the case of compressed air atomizers, the flow of air required for operation of the nozzle according to the present invention can be obtained without requiring to set up costly and bulky compressors that consume large quantities of energy, with simple fans or blowers being sufficient for the purpose.

The air is delivered to the area in which the droplets are formed, immediately downstream of the outlet orifice where the water atomizes, at high velocity, indicatively from 50 to 350 m/s. As atomization of the water is not performed using air, but as a result of the geometry of the spill return nozzle, the velocity imparted to the air is not lost through impact with the jet of water, and therefore the jet of air delivered from the nozzle has a high velocity. This high velocity of the jet of air contributes toward obtaining a double advantage.

Firstly, the high velocity of the jet of air draws with it the particles of atomized water, which translates into increased penetration of the jet of atomized water in the gas to be cooled.

Secondly, the high velocity of the air improves droplet measurement, reducing the diameter of the droplets, i.e. making water atomization more efficient.

A further advantage obtained by the nozzle according to the present invention consists in reduction of the spray angle, which is also maintained constant during regulation of the flow rate. In fact, as described above, the air delivered from the nozzle has an axial-centripetal direction, i.e. is directed against the cone of atomized water so as to oppose opening of the atomization cone. The effect of the flow of air is also that of driving the finest droplets of the jet of atomized water to the inside of the atomization cone, transforming the hollow cone typical of spill return nozzles into a full cone, further improving the efficiency of this nozzle.

The flow of air of the nozzle according to the present invention can be regulated with specific valves or inverters positioned on the fans or blowers so as to optimize the shape of the jet in each point of operation, and naturally it can also be maintained constant.

As stated previously, the high velocity of the jet of air delivered from the nozzle contributes toward increasing the efficiency of the nozzle when this is used for gas cooling. In fact, the increased droplet-gas relative velocity optimizes heat exchange efficiency, reducing evaporation times of the water particles.

Moreover, an advantage obtained by means of the nozzle according to the present invention lies in the fact that the droplets of smaller dimensions, and therefore having lower inertia, are driven by the jet of air toward the inside of the atomization cone of the water, thereby obtaining a final configuration of the cone delivered from the nozzle characterized by the concentration of fine droplets inside the cone and by droplets of larger dimensions at the external periphery of the cone, which is no longer hollow but full.

This final structure of the atomization cone improves operation of the nozzle in terms of efficiency in the gas cooling action. In fact, the larger droplets which are located at the outside of the atomization cone evaporate in contact with the hottest gas. Instead, the finer droplets, which therefore evaporate more rapidly and easily due to their smaller mass, evaporate subsequently also in contact with cooler gas as it has already been partly cooled by the external droplets of the jet.

It has thus been shown how the spill return nozzle according to the present invention achieves the object and the aims proposed.

In particular, it has been shown how the spill return nozzle according to the present invention allows numerous advantages to be obtained in terms of efficiency of this nozzle and greater efficacy in use in gas cooling.

It has in fact been shown how the spill return nozzle according to the present invention allows an increase in the quality of the jet delivered from the nozzle both in terms of droplet distribution and of cone opening.

Moreover, the nozzle according to the present invention presents improved heat exchange efficiency, both due to the velocity and dimension of the droplets forming the atomization cone, and to the distribution thereof.

A further advantage obtained by the nozzle according to the present invention consists in the possibility of maintaining a constant spray angle due to regulation of the flow rate of compressed air, preventing the atomization cone from interfering with any lances located in the vicinity.

Moreover, the jet of air acts to protect the nozzle from dust and dirt in general, which is kept away from the nozzle due to the jet of air, which creates a kind of protective barrier around the nozzle.

In addition, it has been shown how the nozzle according to the present invention allows all the advantages described above to be achieved with modest energy consumption with respect to prior art atomizer nozzles.

Numerous modifications can be implemented by those skilled in the art without departing from the scope of protection of the present invention.

Therefore, the scope of protection of the claims must not be limited by the illustrations or by the preferred embodiments shown in the description by way of example, but instead the claims must comprise all characteristics of patentable novelty deducible from the present invention, including all those characteristics that would be treated as equivalents by those skilled in the art.

1. Spill return nozzle for the atomization of a liquid, particularly suitable for the atomization of water, of the type comprising an annular duct positioned axially for discharge of the flow of liquid delivered from the nozzle, coaxial and internal to said annular duct a return duct for return of part of the flow of liquid in order to regulate the flow rate discharged, and wherein further means suitable to convey a flow of air toward the outlet of said nozzle are comprised.

2. Spill return nozzle as claimed in claim 1, wherein said means suitable to convey a flow of air toward the outlet of the nozzle comprise a hollow cylindrical element that surrounds said ducts defining a further annular duct between the external wall of said annular duct and the internal wall of said hollow cylinder, said annular liner being suitable for a flow of pressurized air to pass through.

3. Spill return nozzle according to claim 2, wherein the internal wall of said hollow cylindrical element presents a first substantially cylindrical section and a second section with converging walls so that the flow of air delivered from the nozzle has an axial-centripetal direction.

4. Spill return nozzle according to claim 3, wherein said means suitable to convey the flow of air toward the outlet of the nozzle also comprise a perforated baffle suitable to center and orient the flow of air passing through said annular sleeve.

5. Spill return nozzle according to claim 4 , wherein said perforated baffle also comprises a plurality of holes suitable to channel and orient the flow of air.

6. Spill return nozzle according to claim 1, wherein said flow of air is composed of a flow of air at low pressure and high velocity.

7. Spill return nozzle according to claim 1, wherein said flow of air is composed of a flow of air with pressure variable from 0.05 to 1 barg.

8. Spill return nozzle according to claim 1, wherein said flow of air has a velocity, at the outlet of the nozzle, variable from 50 to 350 m/s.
